(19) United States
(12) Patent Application Publication
(10) Pub. No.: US 2006/0165089 A1
(43) Pub. Date: Jul. 27, 2006

(54) Method for assisting equivalent circuits in mpls networks

(76) Inventor: Joachim Klink, Muenchen (DE)

Correspondence Address: Siemens Corporation;Intellectual Property Department, 170 Wood Avenue South, Iselin, NJ, 08830, US

(21) Appl. No.: 10/513,344

(22) PCT Filed: May 8, 2003
(86) PCT No.: PCT/DE03/01480

§ 371 Date: Oct. 28, 2004

(30) Foreign Application Priority Data
May 8, 2002 (DE) 102 20 619.8

(51) Int. Cl. H04L 12/56; H04L 12/28

(52) U.S. Cl. 370/395.5; 370/389

(57) ABSTRACT

In the English translation document, please add the paragraph at page 22 line 1, after the newly added ABSTRACT section heading, as follows: The invention relates a suggestion how to provide support for equivalent circuit measures in MPLS networks, using simple means. An MPLS OAM functionality is defined, enabling connectivity and performance monitoring of an MPLS link. According to the invention, said MPLS OAM functionality is taken into account when providing support for MPLS equivalent circuit measures. Said approach is easy to use especially when no very quick switching times are required. A simple express protocol is also defined for quicker switching times.

The invention relates to a method in accordance with the preamble of claim 1.

On the basis of the prior art, the OAM (operation and maintenance) functionality must be considered an essential component of the operation of public communication networks. It supports the quality of network performance while simultaneously reducing the operating costs of the network. In particular, it makes an essential contribution to the quality of service (QoS) of the transmitted information. Strategies relating to OAM functionalities have already been proposed for SONET/SDH and for ATM networks.

The OAM functionality also allows the operator of a communication network to determine at any time whether the guaranteed quality of service (Service Level Agreement) for a connection is being satisfied. For this, the operator must know the availability of existing connections (connection “up” or “down”), the time delay when transferring the information items (Delay, Delay Variation), the deviation—possibly averaged—from otherwise normal intervals between any two information transfers (delay jitter), or the number of information items which were not accepted for transfer at all (blocking rate, error performance).

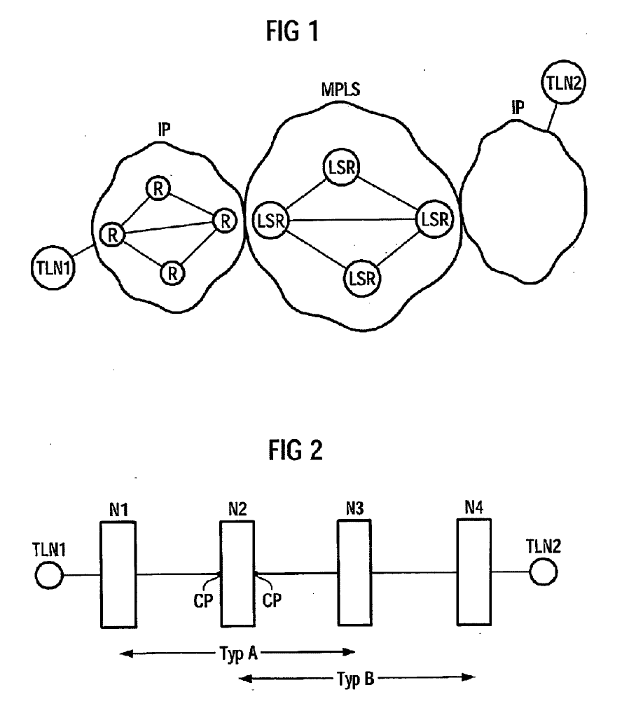

If a connection fails, for example, it must be possible to detect the error immediately (fault detection), to localize the error (fault localization), and if necessary to reroute the connection to an alternate path (protection switching). The traffic flow in the network (traffic flow) and the accounting (billing procedures) can be improved in this way. MPLS networks are currently proposed for transmissions of information in the Internet. In MPLS (Multiprotocol Packet Label Switching) networks, information is transmitted by means of MPLS packets. MPLS packets are of variable length and have a header part and an information part in each case. The header part is used for holding connection information, while the information part is used for holding payload information. IP packets are used as payload information. The connection information which is contained in the header part is embodied as an MPLS connection number. However, this is only valid in the MPLS network. Therefore, when an IP packet from an Internet network enters the MPLS network (FIG. 1), the header part which is valid in the MPLS network is prefixed to it. This header contains all the connection information which specifies the route of the MPLS packet in the MPLS network. If the MPLS packet leaves the MPLS network, the header part is removed again and the IP packet is routed onward within the adjoining Internet network in accordance with the IP protocol. MPLS packets are transmitted unidirectionally.

It is assumed by way of example in FIG. 1 that information originating e.g. from a subscriber TLN1 is supplied to a subscriber TLN2. In this case the sending subscriber TLN1 is connected to the Internet network IP, via which the information is carried in accordance with an Internet protocol, e.g. the IP protocol. This protocol is not a connection-oriented protocol. The Internet network IP has a plurality of routers R which can be intermeshed. The receiving subscriber TLN2 is connected to a further Internet network IP. An MPLS network, through which information is switched in a connection-oriented manner in the form of MPLS packets, is inserted between the two Internet networks IP. This network also includes a plurality of intermeshed routers. In an MPLS network, these can be so-called Label Switched Routers (LSR).

In MPLS networks, the guarantee of the quality of service (QoS) is extremely important. In this context the knowledge of failure situations (signal fail situation) relating to connections in the network plays a significant role for the network operator, since he can implement corresponding alternate circuits for the user depending on this information. However, the prior art does not contribute to resolving this problem.

The object of the invention is to identify a means by which information about failure situations in MPLS networks can be provided with little overhead, and corresponding alternate switching measures can be introduced.

The object of the invention is achieved by the characterizing features, taking as its point of departure the features specified in the preamble of claim 1.

A particular advantage of the invention is the provision of specially embodied MPLS OAM packets which are inserted into the traffic stream of payload data packets. In addition to the label or identification code in the packet header, a further identification code as an MPLS OAM packet is required (in order to distinguish the MPLS OAM packets from the MPLS packets which carry payload data). Packets which are defined in this way are used to monitor the continuity of connections and the transmission performance (performance monitoring) of an MPLS connection (MPLS label switched path). This MPLS OAM functionality is now used for supporting MPLS alternate switching measures. In particular, this procedure is easy to deploy in cases where very fast switching times are not required. A simple express protocol is defined for faster switching times.

Advantageous developments of the invention are specified in the dependent claims.

The invention is explained in greater detail below with reference to an exemplary embodiment and drawings in which:

FIG. 1 shows the basic relationships within an MPLS network,

FIG. 2 shows an end-to-end connection between two subscribers, and

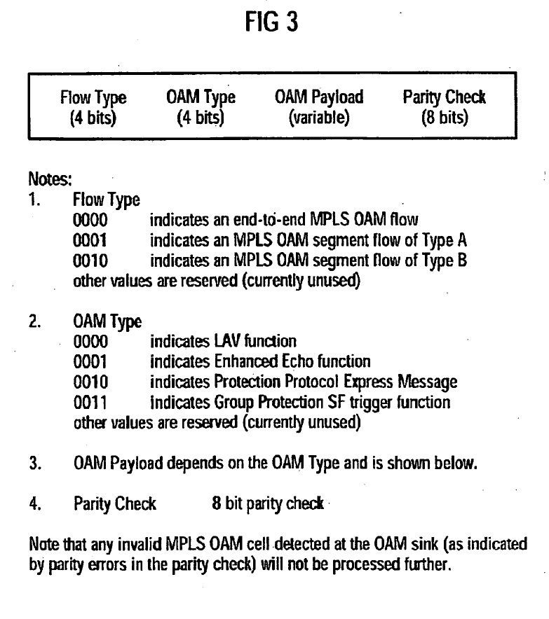

FIG. 3 shows the relationships in the packet header and in the information part of an MPLS OAM packet.

FIG. 2 shows a connection (label switched path, LSP) between two subscribers TLN1 and TLN2. This connection is maintained over a plurality of nodes N1 . . . N4, whereby a plurality of connection sections (label switched hops) are defined. The nodes N1 . . . N4 are implemented as routers LSR of an MPLS network. Following a successful connection setup, an information flow is established between the subscriber TLN1 and the subscriber TLN2, said information flow comprising a plurality of MPLS packets which carry payload data. MPLS OAM packets can be inserted into this MPLS packet flow (inband LSP). Conversely, connections are defined which carry only MPLS OAM packets (outband LSP). In principle, inband MPLS OAM packets are useful for monitoring connections LSP on an individual basis. However, in some cases it can be more advantageous to define an out-of-band MPLS OAM packet flow. An example of this is the MPLS group alternate circuit.

The MPLS OAM packets are labeled in such a way that they can be differentiated from MPLS packets carrying payload data. The special labeling mechanisms are shown in FIG. 3 and are described below in greater detail. The sequence of a plurality of MPLS OAM packets defines an MPLS OAM packet flow. In principle, three different types of MPLS OAM packet flow can exist simultaneously for a connection LSP:

End-to-end MPLS OAM packet flow. This is used in particular when an OAM communication takes place between a source and a sink of a connection LSP. It is made up of MPLS OAM packets which are inserted into the payload data stream at the source of the connection LSP and removed again from the payload data stream at the sink. The MPLS OAM packets can be registered and monitored at the connection points CP along the connection LSP, without any intervention in the transmission process (passive monitoring).

The MPLS OAM packet flow of Type A differs from the end-to-end MPLS OAM packet flow. It is used in particular when an OAM communication takes place between the nodes which delimit a connection section (segment) of Type A (FIG. 2). One or more Type A MPLS OAM segments can be defined in the connection LSP, but they cannot be interleaved or overlap other Type A segments.

Finally, the MPLS OAM packet flow of Type B differs from the two types of packet flow cited above. It is used in particular when an OAM communication takes place between the nodes which delimit a connection section of Type B (FIG. 2). One or more Type B MPLS OAM segments can be defined in the connection LSP, but they cannot be interleaved or overlap other Type B segments.

In principle, an MPLS OAM packet stream (end-to-end, Type A, Type B) is made up of MPLS OAM packets which are inserted into the payload data stream at the beginning of a segment and removed again from the payload data stream at the end of the segment. They can be registered and processed at the connection points CP along the connection LSP, without any intervention in the transmission process. Each connection point CP in the connection LSP, including the sources and the sinks of the connection, can be configured as an MPLS OAM source or an MPLS OAM sink, wherein the outgoing MPLS OAM packets from an MPLS OAM source are preferably configured as “upstream”.

Before MPLS OAM packets (end-to-end, Type A, Type B) are transmitted over the MPLS network, the endpoints (source, sink) of the associated MPLS OAM segment must be defined. The definition of source and sink for an MPLS OAM segment is not necessarily permanently specified for the duration of the connection. This means that the relevant segment can be reconfigured via fields in the signaling protocol, for example.

An interleaving of the segmented MPLS OAM packet flow (Type A or Type B) within an end-to-end MPLS OAM packet flow is possible for each connection LSP. In this case, the connection points CP can be simultaneously source/sink of a segment flow (Type A or Type B) and also of the end-to-end MPLS OAM packet flow.

The Type A MPLS OAM packet flow (segment flow) is functionally independent of the Type B MPLS OAM packet flow with regard to inserting removing and processing the MPLS OAM packets. The interleaving of Type B MPLS OAM packets with Type A MPLS OAM packets and vice versa is therefore generally possible. In the case of interleaving, a connection point CP can therefore even be source and sink simultaneously of a segment flow of Type A and of Type B.

The overlapping of Type A segments with Type B segments is possible depending on the network architecture. For example, Type A segments can overlap Type B segments in the case of a point-to-point architecture. Both segments can operate independently of each other and therefore have absolutely no effect on each other. However, the overlapping can cause problems in MPLS alternate circuits.

The differentiation between MPLS OAM packets and MPLS packets which carry payload data can be made by using one of the EXP bits in the MPLS packet header. In particular, this approach offers a very simple differentiation option. This bit can be checked at the sink of an MPLS OAM segment or at the connection points CP, in order to filter out MPLS OAM packets before further analyses are undertaken.

Alternatively, one of the MPLS connection numbers (MPLS label values) 4 to 15 in the header part of the MPLS packet can be used as an identification code. These MPLS connection numbers were reserved by the IANA. In this case the next identification code in the stack must indicate the assigned connection LSP for which the inband OAM functionality is implemented. This solution is rather more complex to implement, since the hardware in the OAM sink and the connection points CP requires two MPLS stack inputs for each MPLS OAM packet. Of course, the processing must take place in real time, i.e. the OAM packets must be reinserted into the flow, maintaining the sequential order, at the connection points CP. This is essential in order to ensure accurate performance monitoring results at the OAM sink.

MPLS OAM LAV packets are defined for monitoring (verifying) the availability of an MPLS connection LSP (this is subsequently designated as the MPLS LAV function). These are inserted into the flow of payload information (inband flow) and are assigned to a specific connection LSP. The availability of a connection LSP can be determined on an end-to-end basis or on a segmented basis in this way. In such cases, an MPLS OAM LAV packet provided for this purpose is inserted periodically per time interval (e.g. per second) at the source and its arrival is monitored periodically per time interval (e.g. per second) at the sink. If no MPLS OAM LAV packet is received at the sink after a predefined time (of e.g. several seconds) and if applicable after multiple checking (e.g. 2 to 3 times), the connection LSP is declared unavailable (LSP=“down” or “unavailable”). In the case of the unavailable connection LSP, the arrival of the MPLS OAM LAV packet continues to be checked periodically at the sink, and if it is received again at the sink after a predefined time (of several seconds), the connection is declared as available again.

The MPLS LAV function can be activated simultaneously on an end-to-end basis or a segmented basis for each connection LSP at any interface CP or network element. Activation and deactivation can be performed using signaling procedures or manual configuration via network management. The activation can take place at any time, i.e. either during connection setup or subsequently.

If a segment is monitored, the limits of the relevant segment within the assigned connection LSP must first be specified. This is normally achieved by firstly determining source and sink. The MPLS LAV function can then be activated. It must be inactive, however, if the limits of a segment are to be changed or if the segment is to be deleted, which is possible at any time.

The advantage of the MPLS LAV function is the ability to check whether the agreed (Service Level Agreement) quality of service parameters of the relevant connection LSP have also been satisfied. In particular, the availability status is of interest here, i.e. whether the connection LSP is available (LSP=“up” or “available”) or not (LSP=“down” or “unavailable”). The failure of a connection LSP (signal fail situation) can therefore be detected. In this case an MPLS alternate circuit can be initiated or an alarm can be generated and optionally forwarded to the network operator.

The availability status of the connection LSP (LSP=“available” or “unavailable”) is now taken as a basis for further information. The availability status is an indicator for the occurrence of the failure of a connection (signal fail situation). In the case of unavailability, a “Signal Fail” signal is activated. In the case of availability of the connection, this signal is deactivated. This signal can therefore be used for initiating alternate switching requirements (MPLS protection switching) or alarms. Furthermore, the location of the underlying network fault can be determined within the framework of diagnostic measures.

A further and purely passive monitoring function (non-intrusive monitoring function) can be provided as an additional function to the monitoring function (MPLS LAV function). In this case, the MPLS OAM LAV packets are only read during the monitoring operation, and are not changed (non-intrusive). They can be determined on an end-to-end basis or a segment basis at any of the connection points CP along the MPLS OAM LAV traffic flow, by processing the content of the MPLS OAM LAV packets which pass through the connection point CP, without changing characteristic variables such as e.g. the content of the packets. The monitoring is done in addition to the e.g. end-to-end monitoring, i.e. individual segments of the overall connection are checked in this case. In this context, the passive monitoring includes the same functionality as described for the MPLS LAV function.

The advantage of the passive monitoring function can be seen in the localization of errors. This allows the implementation of a step-by-step method with which it possible to determine which parts of the connection LSP are interrupted. The degradation of the transmission quality (signal degrade) can likewise be determined.

The MPLS LAV function also forms the basis for monitoring the transmission performance (performance monitoring). In this context, the function which handles the transmission performance monitoring (subsequently referred to as the PM function) should be considered as a subfunction of the MPLS LAV function.

The PM function is used for monitoring the transmission quality on a connection on an end-to-end basis or on a segment basis. In this context, the number of MPLS LAV packets which go missing per time interval during the transmission is as significant as the number of packets which are incorrectly inserted. A time interval of 1 second, for example, can be used as a time interval (one-second interval). For this purpose, the MPLS OAM LAV packet contains a special field for storing a packet counter.

The monitoring of transmission performance is now carried out by initially counting, at the source, the number of MPLS packets carrying payload data which are sent and are transmitted per second for the relevant connection. The value thus obtained is then transmitted to the sink, where it is compared with the status of a further counter which contains the number of MPLS packets carrying payload data which arrived at the sink. The number of packets which were lost during the transmission or were incorrectly inserted can be determined by comparing both values.

The PM function can only be activated if the (associated) MPLS LAV function is active. If this is the case for a specific connection, the PM function can be active or inactive as required. Activation and deactivation of the PM function can be performed using signaling procedures or alternatively using manual configuration.

The PM function is used in order to determine whether the agreed (Service Level Agreement) and guaranteed quality of service (QoS) of the assigned connection LSP has also been satisfied. This includes, for example, the requirements in relation to error performance. It is also possible to determine whether the guaranteed throughput for the connection has actually been satisfied by the network.

The PM function can also be used in order to detect the degradation of a signal (signal degrade) for a connection LSP. In this case, MPLS protection switching can be initiated as a consequence. Alternatively, an alarm can also be generated and forwarded to the network operator, for example. MPLS traffic engineering can be provided as a further application, so that overload situations in the network can be determined.

When the PM function is active, an asynchronous counter at the source counts the number of MPLS packets carrying payload data which are sent for the corresponding connection LSP. MPLS packets carrying payload data, in this context, means all those packets which are not labeled as OAM packets. The counter can be implemented as a 16-bit counter, for example (asynchronous, modulo 65536). Each time an MPLS LAV packet is inserted into the MPLS LAV traffic flow of the relevant connection LSP (e.g. per second), the current value of the counter is written into the corresponding field of the MPLS LAV packet. This means that on the sending side (source), the difference between two successive counter statuses corresponds to the number of MPLS packets carrying payload data, which have been transmitted between two consecutively sent MPLS OAM LAV packets.

When the PM function is active, a further asynchronous counter at the sink counts the number of MPLS packets carrying payload data which arrive (for this connection LSP). This counter is likewise implemented as a 16-bit counter (asynchronous, modulo 65536). Each time an MPLS OAM LAV packet is received for the relevant connection LSP (e.g. per second), the following calculations are carried out in real-time processing (i.e. within the transmission time of an MPLS packet carrying payload data):

In a first calculation step, the difference is formed between the current counter status (after determining the number of received MPLS packets carrying payload data) and the status which the counter had when the last MPLS OAM LAV packet was analyzed. The result corresponds to the number of MPLS packets carrying payload data, which arrived within the one-second interval for this connection LSP.

In a second calculation step, the counter status which was transmitted with the MPLS OAM LAV packet is read and subtracted from the value of the counter status which was transmitted with the previously received MPLS OAM LAV packet. The result corresponds to the number of MPLS packets carrying payload data which were sent at the source within the one-second interval for this connection LSP.

The difference between the two calculations corresponds to the number of packets which were lost within the last one-second interval for the relevant connection LSP (assuming that more packets were sent than received). This result is saved for this time interval. If more packets are received than were sent, it is assumed that packets have been erroneously inserted somewhere during the transmission in this connection LSP. An asynchronous one-second counter at the sink then performs the further processing.

If the status of the associated connection LSP is “down” or “unavailable”, the activation of the PM function is disabled until the status of this connection is “up” or “available” again.

If the information relating to the PM function is lost, said information being contained in an MPLS OAM LAV packet, no major problems should be anticipated. In this case, the next received packet containing information relating to the PM function is simply analyzed and the result is applied to a two-second interval.

Using a 16-bit counter—as described above—it is possible to accurately calculate connections having a throughput of 10 Gbit/sec (corresponding to approximately 300 million IP packets per second) and packet loss rates of up to at least 10⁻⁴. IP packets having the smallest possible size are assumed in this context. For higher packet loss rates, the results can be less accurate, though it is probable that the connection will be declared interrupted (signal fail) and unavailable under these circumstances, and therefore the performance monitoring results are invalid in any case.

If both the loss and the erroneous insertion of packets occur consecutively, the results will partially average out. However, it can be assumed in this context that this does not represent a usual situation in normal operation.

The results in relation to loss rates or erroneous insertion of packets per one-second interval are taken as a basis for further calculations:

Using this information, it is therefore possible to determine whether the degradation of a signal (signal degrade situation) has occurred. If this is the case, e.g. MPLS protection switching can be initiated. Furthermore, the results for a one-second interval can be accumulated into a 15-minute interval. As a result, corresponding statements for a 15-minute interval can therefore be made. These are saved and if necessary forwarded to the network management. Further intervals such as 24-hour intervals, for example, are also possible.

It is also possible to monitor the transmission performance of the connection or connection segment at any of the network devices which are situated between source and sink. On the basis of the information about the transmission performance of the MPLS connection at any MPLS network devices which are situated between source and sink, it is possible to locate the underlying network error within the framework of diagnostic measures.

According to the invention, the OAM functionality described above is also used for providing support for MPLS protection switching devices. The basic functionality of MPLS protection switching devices is described in the German patent application having the official file reference 19646016.6.

In principle, support is therefore required on the part of the MPLS OAM functionality in order to determine failure situations (signal fail situation) of an assigned connection LSP. The relevant information should then be sent to the sink of the section which is to be protected, whereupon the switching to an alternate path (protection switching) can be initiated.

Particularly demanding requirements in relation to the switching time must be specified in the case of MPLS group alternate circuits (group protection switching). In this case, switching times such as those used in SDH/SONET networks are required. In order to achieve this, an advanced MPLS OAM functionality is required.

In addition, support is therefore also required on the part of the MPLS OAM functionality in order to determine a degradation of the transmission quality (signal degrade situation) on an assigned connection LSP and to send the relevant information to the sink of the section which is to be protected, where the switching to an alternate path (protection switching) can be initiated.

Finally, support is required on the part of the MPLS OAM functionality in order to achieve the transmission, between source and sink of the section which is to be protected, of the control information which causes the switching. In particular, this applies to those configurations in which a control protocol is required in order to carry out the switching. The control information which causes the switching is stored in the form of a K1/K2 byte.

According to the invention, the determining of failure situations (signal fail) on an assigned connection LSP is carried out by the MPLS LAV function. For this purpose, one MPLS OAM LAV traffic flow (on an end-to-end basis or on a segment basis) is configured for the current operating path LSP, and a further one is configured for the alternate path LSP. The failure of the signal (signal fail) can then be determined at the OAM sink and the switching operations can be initiated as a consequence.

When using the MPLS LAV function for determining failure situations, the problem occurs that the relevant time intervals (detection times) are in the order of several seconds. This is not acceptable for MPLS group alternate switching configurations.

For this reason, an MPLS OAM function is defined for rapid triggering of the alternate circuit when failure situations occur (FSFT function, Fast Signal Fail Trigger function). The functionality is the same as for the MPLS LAV function, except for the fact that an OAM packet is inserted every 10 ms (instead of once per second) at the source. The analysis at the sink is based on a 10 ms counter instead of a 1-second counter accordingly. Consequently, the failure of a signal is determined at the sink after a maximum time of 30 ms following the occurrence of the interruption. The further processing can then be initiated immediately. The purely passive monitoring function (non-intrusive monitoring function), which is additional to the MPLS LAV function, is not required here. The same applies to functions for monitoring the transmission quality (performance monitoring, PM function).

In order to use the FSFT function for the MPLS group alternate circuit, one OAM traffic flow (on an end-to-end basis or a segment basis) must be configured for a control connection on the operating path (working entity) and a further one must be configured for a control connection on the alternate path (protection entity). The failure of a signal is then determined on these control connections, whereupon the alternate switching measures are initiated for the whole group.

The FSFT function can also be used (if required) for individual MPLS alternate circuits, in order to achieve reduced alternate switching times. In this case, both the MPLS LAV traffic flow and the MPLS OAM FSFT traffic flow (Fast Signal Trigger OAM flow) are configured simultaneously for the assigned connection LSP, and on both the active operating path (working entity) and on the alternate path (protection entity). The triggering of the alternate circuit in failure situations does not then take place on the basis of the monitoring of the MPLS LAV traffic flow, but rather on the basis of the rapid MPLS LAV FSFT traffic flow.

The degradation of the transmission quality of a signal (signal degrade) can be established with the aid of the PM (Performance Monitoring) function. For this, one MPLS LAV traffic flow (on an end-to-end basis or a segment basis) must be configured in each case for the active operating path as well as for the alternate path of the connection LSP. The degradation of the transmission quality can then be determined at the OAM sink, whereupon MPLS alternate switching measures are initiated. This functionality is used for determining the degradation of the transmission quality in individual MPLS alternate switching configurations. The MPLS group alternate circuit is not described further here, but the functionality is far more complex in this case and also makes use of the performance monitoring subfunction of the MPLS LAV function.

Two transmission functions are described for transmitting the alternate switching protocol. The first function is designated as a normal transmission function and the second is designated as an accelerated transmission function:

In those cases where the MPLS LAV function is used as a trigger for failure situations for MPLS alternate switching configurations, this functionality can also be used for the transmission of the alternate switching protocol. Information relating to the alternate circuit is stored in the alternate switching protocol and is transmitted between source and sink of the section which is to be protected. The K1/K2 bytes of the alternate switching protocol are then transmitted in the payload of the MPLS OAM LAV packets. The corresponding format is shown in FIG. 3. The current K1/K2 byte send status is inserted per second into the MPLS OAM LAV packet at the source. In the case of a change in the K1/K2 send status, this change is transmitted in the next MPLS OAM LAV packet. The MPLS OAM LAV packet is removed from the traffic flow at the sink. The K1/K2 bytes contained in the payload are then made available to the MPLS alternate switching function for further processing.

The relatively slow mechanism of the normal transmission function is not acceptable for MPLS group alternate switching configurations, where rapid alternate circuit switching is required. For this reason, an MPLS OAM alternate switching protocol express message (accelerated transmission function) is defined, said message including an extension of the OAM LAV functionality.

Whenever a status change of the alternate switching protocol byte has been determined and is awaiting transmission, an MPLS OAM alternate switching protocol express message is transmitted immediately, instead of waiting for the next MPLS OAM LAV packet (1× per second). The OAM format of this packet is shown in FIG. 3. When such a message is received at the sink, processing is started immediately and the alternate switching protocol information is extracted from the OAM packet and supplied to the MPLS alternate switching functionality. The immediate initiation of processing at the sink can be achieved, for example, by checking an incoming OAM packet to determine whether the function type matches that of an alternate switching express message. This is the case if it has the value “0010”.

The accelerated transmission function should be activated at the same time as the rapid FSFT function in order to achieve rapid alternate switching for MPLS group alternate switching configurations. Moreover, both mechanisms can also be used for MPLS alternate switching configurations on an individual basis.

1.-6. (canceled)

7. A method for connection-oriented transmission of variable-length packets over a connection, the connection including a plurality of connection sections, comprising:
labeling some of the packets;
supplying an identifier to some of the labeled packets; and
supporting an alternate switching method by including information in the packets.

8. The method as claimed in claim 7, wherein the variable-length packets are transmitted via a multiprotocol label switching method.

9. The method as claimed in claim 8, wherein the packets are MPLS packets, the labeled packets are MPLS OAM packets, and the MPLS OAM packets including the identifier are MPLS OAM LAV packets.

10. The method as claimed in claim 8, wherein the information includes an alternate switching protocol information enabling a coordination of the alternate switching method between a source and a sink.

11. The method as claimed in claim 10, wherein a status change of the alternate switching protocol information on a sending side is transmitted in the next MPLS OAM LAV packet, the MPLS OAM LAV packet inserted after a designated time period and subsequently forwarded to an MPLS alternate switching function for processing on a receiving side.

12. The method as claimed in claim 10, wherein a triggering of an alternate switching function is ensured when a status change of the alternate switching protocol information on a sending side is transmitted in the MPLS OAM LAV packet, the packet is identified as an express message, inserted immediately after the status change and analyzed immediately after its receipt on a receiving side.

13. The method as claimed in claim 10, wherein some of the MPLS OAM LAV packets are alternate switching trigger messages, the messages are inserted prior to one second, and are analyzed after their receipt to ensure a triggering of the alternate switching function.

14. The method as claimed in claim 13, wherein the designated time period is one second.

15. A mutiprotocol label switching network, comprising:
a connection maintained over a plurality of nodes, the nodes implemented as label switched routers, the connection including a connection section;
a plurality of variable length MPLS packets;
an alternate switching method information included in some of the MPLS packets for supporting a MPLS alternate switching method;
a label included in some of the MPLS packets; and
an indicator included in some of the labeled packets,
wherein a link is selected from the group consisting of the connection and the connection section,
wherein the variable length packet is transmitted over the link.

16. The network as claimed in claim 15, wherein the labeled packets are MPLS OAM packets, and the MPLS OAM packets including the identifier are MPLS OAM LAV packets.

17. The network as claimed in claim 15, wherein the alternate switching method information transmitted for supporting the MPLS alternate switching method includes an alternate switching protocol information enabling a coordination of the MPLS alternate switching method between a source and a sink.

18. The network as claimed in claim 17, wherein the alternate switching protocol information is transmitted in the next MPLS OAM LAV packet after a status change of the alternate switching protocol information on a sending side.

19. The network as claimed in claim 15, wherein a status change of the alternate switching protocol change triggers a transmission of a MPLS OAM LAV packet identified as an express message, the express message includes the status change and is inserted immediately after the status change on a sending side.

20. The network as claimed in claim 19, wherein the express message is analyzed immediately after its receipt.

21. The network as claimed in claim 15, wherein some of MPLS OAM LAV packets are identified as alternate switching trigger messages and are transmitted with a periodicity of less than one second.

22. The network as claimed in claim 21, wherein the alternate switching trigger messages are analyzed immediately upon receipt.
